(19) United States
(12) Patent Application Publication
(10) Pub. No.: US 2006/0051203 A1
(43) Pub. Date: Mar. 9, 2006

(54) High volume fan device for removing heat from heat sources

(76) Inventors: Sen-Yung Lee, Tainan City (TW); Shueei-Muh Lin, Tainan City (TW); Hsin-Mao Hsieh, Pin-Tong City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/936,480

(22) Filed: Sep. 9, 2004

(51) Int. Cl. F03B 3/16

(52) U.S. Cl. 415/204

(57) ABSTRACT

A fan device includes a base having a recess in which a fan unit is received. A hole is defined through a second side of the base and a first outlet is defined in an end of the base. The fan unit includes two rings and a motor is located at a center of the first ring. A plurality of inner blades extend from an inner periphery of the first ring and are connected to the motor. A plurality of outer blades connected between the two rings. The air flow is sucked and blown out by a larger volume so as to efficiently remove heat from CPU.

### FIELD OF THE INVENTION

The present invention relates to a fan device including inner blades and outer blades connected to at least one ring so as to remove heat at high volume.

### BACKGROUND OF THE INVENTION

A conventional fan device “A” for removing heat from a hear source such as a CPU in a computer is disclosed in FIG. 1 and generally includes a fan unit 2 that is composed of a plate 22 with a plurality of blades 21 extending perpendicularly from a side of the plate. A base 1 with a recess 11 defined in a side thereof so as to receive the fan unit 2 in the recess 11. An outlet 12 is defined in an end of the base 1 and a cover 3 is mounted to the base 1. A hole 31 is defined through the cover 3 and the fan unit 2 is enclosed by the hole 31. It is noted that the volume of air sucked by the fan unit 2 and the pressure of the air flow are not stable and disadvantageous for the efficiency of removal of heat.

The present invention intends to provide a fan device that includes at least one ring and a motor, a plurality of inner blades connected between the motor and the at least one ring, and a plurality of outer blades extending from an underside of the at least one ring. The fan device has higher efficiency of sucking air and removing heat.

### SUMMARY OF THE INVENTION

The present invention relates to a fan device that comprises A fan device that comprises a base having a recess defined in a first side thereof so as to receive a fan unit therein and a hole is defined through a second side of the base. A first outlet is defined in an end of the base. The fan unit includes a first ring and a motor is located at a center of the first ring. A plurality of inner blades extend from an inner periphery of the first ring and are connected to the motor. A plurality of outer blades extend from an underside of the first ring.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows an exploded view of a conventional fan device;

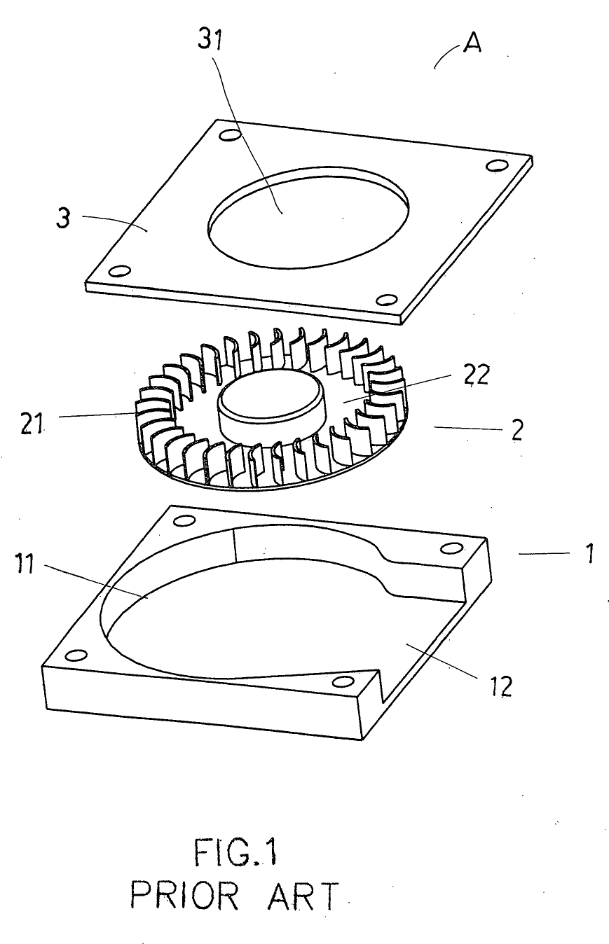

FIG. 2 is a side cross sectional view of the conventional fan device;

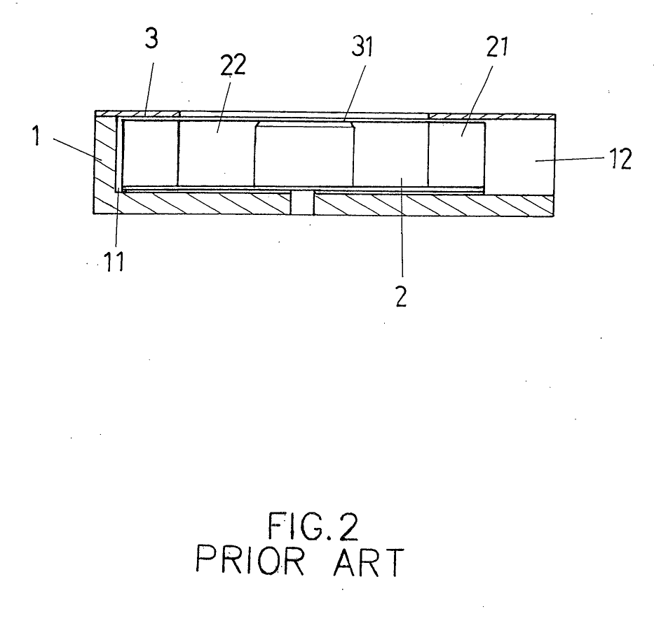

FIG. 3 is an exploded view to show the fan device of the present invention;

FIG. 4 shows a perspective view of the fan device of the present invention;

FIG. 5 is an exploded view to show another embodiment of the fan device of the present invention, and

FIG. 6 is a side cross sectional view of the fan device of the present invention in FIG. 5.

### DETAILED DESCRIPTION OF THE PREFERRED EMBODIMENT

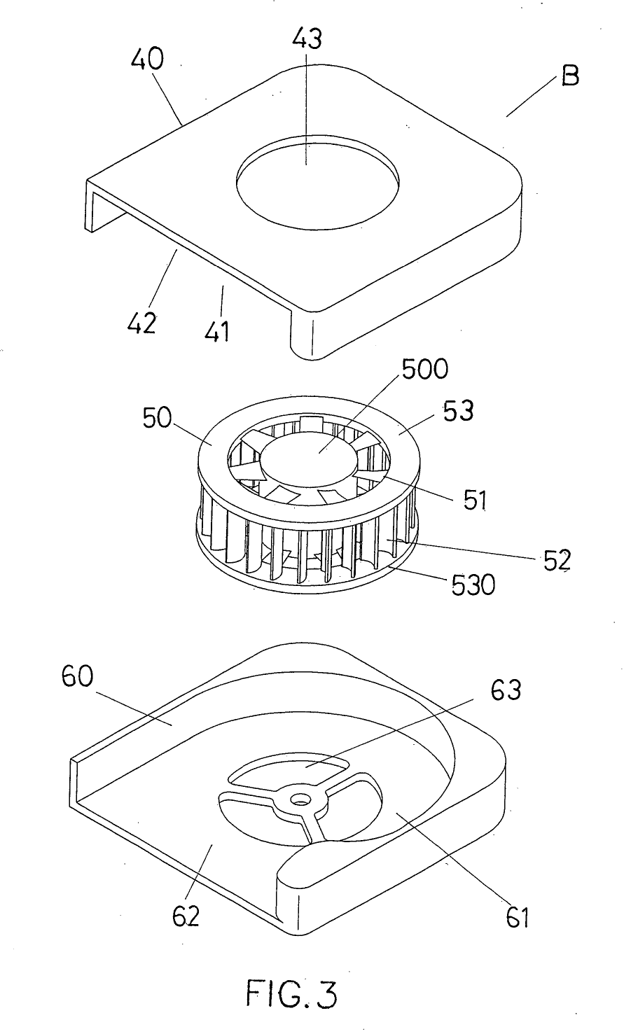

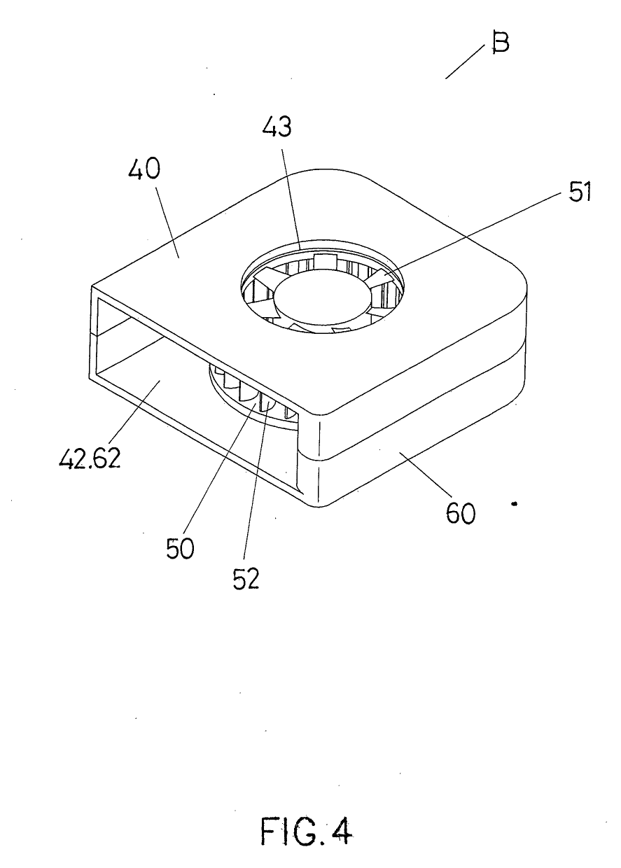

Referring to FIGS. 3 and 4, the fan device “B” of the present invention comprises a base 60 having a recess 61 defined in a first side thereof and three holes 63 are defined through a second side of the base 60. A first outlet 62 is defined in an end of the base 60.

A fan unit 50 is received in the recess 61 and includes a first ring 53 and a second ring 530 which is co-axially located at a distance from the first ring 53. A motor 500 is located at a center of the first and second rings 53, 530. A plurality of curve inner blades 51 extend from an inner periphery of the first ring 53 and are connected to the motor 500. A plurality of outer blades 52 extend from an underside of the first ring 53 and distal ends of the outer blades 52 are connected to the second ring 530.

A cover 40 has a recess 41 defined in an underside thereof and a hole 43 is defined through the cover 40. The cover 40 is connected to the base 60 and the fan unit 50 is located within the hole 43. A second outlet 42 defined in an end of the cover 40 and cooperated with the first outlet 62 of the base 60 to form a large outlet.

The two rings 53, 530 provide the fan unit 50 a strong structure and the fan unit 50 does not shake during operation. There is no limitation of the height for the inner and outer blades 51, 52 and air can be sucked from two sides of the fan unit 50 so that heat is removed by large volume.

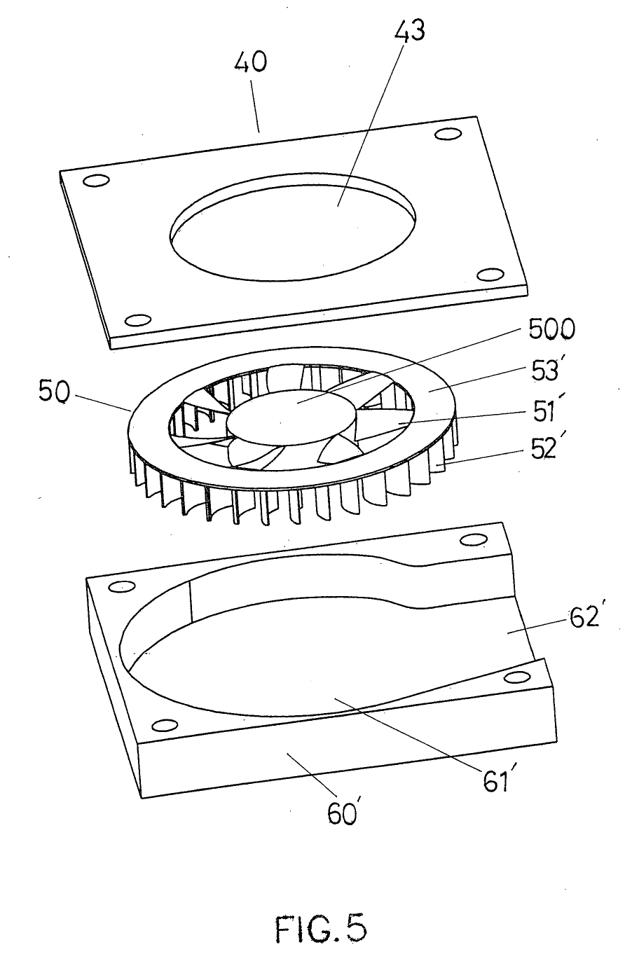

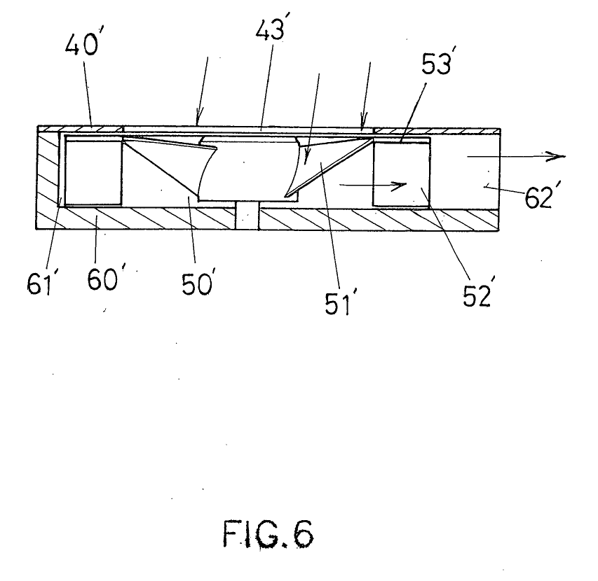

FIGS. 5 and 6 show another embodiment of the fan device which includes a base 60′ having a recess 61′ defined in a first side thereof and an outlet 62′ is defined in an end of the base 60′. A fan unit 50′ is received in the recess 61′ and includes a first ring 53′ and a motor 500 is located at a center of the first ring 53′. A plurality of curve inner blades 51′ extend from an inner periphery of the first ring 53′ and are connected to the motor 500. A plurality of outer blades 52′ extend from an underside of the first ring 53′. A cover 40′ has a hole 43′ is defined therethrough and the cover 40′ is connected to the base 60′ and the fan unit 50′ is located within the hole 43′.

While we have shown and described the embodiment in accordance with the present invention, it should be clear to those skilled in the art that further embodiments may be made without departing from the scope of the present invention.

What is claimed is:

1. A fan device comprising:
a base having a recess defined in a first side thereof and a hole defined through a second side of the base, a first outlet defined in an end of the base, and
a fan unit received in the recess and including a first ring and a motor located at a center of the first ring, a plurality of inner blades extending from an inner periphery of the first ring and connected to the motor, a plurality of outer blades extending from an underside of the first ring.

2. The fan device as claimed in claim 1 further comprising a second ring connected to distal ends of the outer blades.

3. The fan device as claimed in claim 1 further comprising a cover having a hole defined therethrough and the fan unit located within the hole.

4. The fan device as claimed in claim 3 further comprising a second outlet defined in an end of the cover.
